(19) United States
(12) Patent Application Publication
(10) Pub. No.: US 2026/0366976 A1
(43) Pub. Date: Nov. 19, 2026

(54) LIQUID PARTICLE MONITORING SYSTEM UTILIZING AEROSOL METROLOGY AND DATA PROCESSING ALGORITHM

(71) Applicant: FOUNDATION FOR RESERCH AND BUSINESS, SEOUL NATIONAL UNIVERSITY OF SCIENCE AND TECHNOLOGY, Seoul (KR)

(72) Inventors: Dong Bin KWAK, Seoul (KR); Seong Min Cho, Seoul (KR)

(73) Assignee: FOUNDATION FOR RESERCH AND BUSINESS, SEOUL NATIONAL UNIVERSITY OF SCIENCE AND TECHNOLOGY, Seoul (KR)

(21) Appl. No.: 19/324,292

(22) Filed: Sep. 10, 2025

(30) Foreign Application Priority Data
May 16, 2025 (KR) 10-2025-0064058

(51) Int. Cl. G01N 15/02; G01N 15/06

(52) U.S. Cl. CPC G01N 15/02; G01N 15/06

(57) ABSTRACT

Disclosed is a liquid particle monitoring system, and more particularly, technology for accurately analyzing the size distribution and concentration of particles within a liquid sample using aerosol metrology and a data processing algorithm. A system in which an atomizer and a scanning mobility particle sizer (SMPS) are integrated may aerosolize a liquid sample, may identify a nonvolatile residue (NVR) mode and a particle mode through multimodal lognormal fitting, and then may convert the aerosol size distribution to the hydrosol size distribution by applying a correction function based on standard particle data. In particular, the system may restore the consistent particle size distribution and concentration of an original sample under various dilution conditions by effectively removing nonvolatile residues and by correcting a dilution factor.

### CROSS-REFERENCE TO RELATED APPLICATION(S)

This application claims priority from and the benefit of Korean Patent Application No. 10-2025-0064058 filed on May 16, 2025, which is hereby incorporated by reference in its entirety.

### BACKGROUND

### 1. Field

The present invention relates to a liquid particle monitoring system, and more particularly, to technology for accurately analyzing the size distribution and concentration of particles in a liquid sample using aerosol metrology and a data processing algorithm. Specifically, the present invention relates to a method and device for removing nonvolatile residues from measurement data of aerosolized particles and accurately restoring the hydrosol distribution of an original sample.

### 2. Related Art

In modern science and industry, the advancement of nanoparticle technology has led to the application of various engineered nanomaterials in various fields, such as materials science, chemical engineering, an energy systems, environmental technology, healthcare, and semiconductor manufacturing. Transition of particle technology from microscale to nanoscale has facilitated the utilization of engineered nanomaterials in various application fields.

The comprehensive understanding of the characteristics and properties of nanoparticles is essential for their optimal utilization. Accurate characterization including the particle number concentration and the particle size distribution (PSD) is important to improve the performance and to mitigate the potential risks.

In particular, this plays a crucial role in the field in which precision and safety are critical, such as healthcare, environmental management, and microchip manufacturing.

The existing liquid particle (hydrosol) analysis methods include optical-based techniques, such as a liquid particle counter (LPC) and a dynamic light scattering (DLS) method. The LPC uses an optical-based method to detect and quantify the size and concentration of particles in liquid and is technology widely used in the semiconductor and pharmaceutical industry.

However, the LPC has several limitations in terms of nanoparticle analysis. Due to an optical coincidence phenomenon that a plurality of particles are misclassified as a single entity, the concentration in a high concentration solution may be underestimated.

Also, due to dependence on correction using standard particles, such as polystyrene latex (PSL) spheres, inaccuracy arises when characterizing target particles with different refractive indices, such as silica and ceria.

In addition, there are disadvantages that detection accuracy is limited since particles less than 30 nm may be excluded, and it is also difficult to perform an analysis in a polydisperse solution in which particles of various sizes coexist.

The DLS method is also commonly used for liquid particle measurement, but has a notable drawback. This method uses an intensity-based approach, which distorts the size distribution—a critical issue since particle size distribution is an important factor for accurate polishing performance.

Also, dependence of refractive index according to the particle size presents an additional challenge for detecting a material with a refractive index close to that of the medium.

Aerosol detection technology, such as a scanning mobility particle sizer (SMPS), has emerged as an important tool for characterizing nanoparticles in various application fields, including chemical mechanical polishing (CMP) slurry analysis.

SMPS enables precise characterization of the particle size distribution in polydisperse and multimodal systems by classifying and measuring nanoparticles using electrical mobility. However, there is an interference issue caused by nonvolatile residues (NVR) formed when aerosolizing a liquid sample, and an algorithm to accurately remove and compensate for the interference is required.

Therefore, there is a need to develop a new system that may accurately analyze the size distribution and concentration of particles in a liquid sample by combining aerosol metrology and a data processing algorithm.

In particular, technology is required that may remove the influence of nonvolatile residues and may restore the consistent properties even under various dilution conditions.

Patent documents include U.S. Patent Laid-Open Publication No. 2013-0077096 titled “METHOD AND APPARATUS FOR MEASURING A POSITION OF A PARTICLE IN A FLOW” and Korean Patent Registration No. 10-1746148 “DEVICE FOR COLLECTING LIQUID AND METHOD WITH THE SAME.”

### SUMMARY

The present invention aims to effectively remove interference caused by nonvolatile residues in a liquid particle (hydrosol) characterization process using aerosol metrology.

The present invention aims to provide a systematic and reliable algorithm for converting the aerosol size distribution (ASD) to the hydrosol size distribution (HSD).

The present invention aims to accurately restore the consistent hydrosol distribution of an original sample for a sample measured at various dilution factors (DFs).

The present invention aims to improve the characterization accuracy of hydrosols of various materials and sizes through correction using standard nanoparticles.

The present invention aims to provide high-resolution particle analysis technology that overcomes the limitations found in the existing liquid measurement methods in the industrial application field, such as chemical mechanical polishing (CMP) slurry.

The present invention aims to provide a method that may accurately analyze the particle size distribution even in complex polydisperse and multimodal particle systems through multimodal fitting technology.

The present invention aims to develop a system that improves the accuracy and efficiency of nanoparticle characterization by integrating aerosol metrology and a data processing algorithm.

A liquid particle monitoring system according to an example embodiment includes a data receiver configured to receive aerosol size distribution (ASD) data acquired through measurement of aerosolized particles; a mode identification unit configured to identify a nonvolatile residue (NVR) mode and a particle mode by applying multimodal lognormal fitting to the aerosol size distribution data; an NVR removal unit configured to remove the identified nonvolatile residue mode, and to generate aerosol particle size distribution (APSD) that includes only a pure particle mode; a distribution conversion unit configured to convert the aerosol particle size distribution to its corresponding hydrosol particle size distribution (HPSD) based on a correction function using standard particle data; and a dilution correction unit configured to calculate the particle size distribution and concentration of an original liquid sample by applying a dilution factor (DF).

The mode identification unit of the liquid particle monitoring system according to an example embodiment may classify, as the nonvolatile residue mode, a mode of which a geometric mean diameter is less than a preset cutoff size among fitted modes, and to classify, as the particle mode, a mode of which a geometric mean diameter is greater than or equal to the cutoff size.

The mode identification unit of the liquid particle monitoring system according to an example embodiment may include a duplicate mode merging function for merging particle modes within the same size range into a single particle mode.

In the liquid particle monitoring system according to an example embodiment, the plurality of particle modes may be margined into a single mode when a difference between the geometric mean diameters is less than 10% of their average diameter.

The distribution conversion unit of the liquid particle monitoring system according to an example embodiment may use the correction function based on standard polystyrene latex (PSL) nanosphere measurement data.

The liquid particle monitoring system according to an example embodiment may further include a diameter calculation unit configured to calculate the representative average particle diameter (μᵣₑₚ) from the aerosol particle size distribution (APSD), and the distribution conversion unit may be configured to determine the coefficient of the correction function according to the representative average particle diameter.

The dilution correction unit of the liquid particle monitoring system according to an example embodiment may restore the liquid particle concentration of an original sample for a sample measured at a plurality of dilution factors (DFs).

The mode identification unit of the liquid particle monitoring system according to an example embodiment may identify two to four modes through the multimodal lognormal fitting.

The liquid particle monitoring system according to an example embodiment may be used to analyze the abrasive particle size and concentration of chemical mechanical polishing (CMP) slurry.

In the liquid particle monitoring system according to an example embodiment, the chemical mechanical polishing slurry may include silica or ceria abrasives.

A hydrosol monitoring method according to an example embodiment includes receiving aerosol size distribution (ASD) data acquired through measurement of aerosolized particles; identifying a nonvolatile residue (NVR) mode and a particle mode by applying multimodal lognormal fitting to the aerosol size distribution data; removing the identified nonvolatile residue mode, and generating aerosol particle size distribution (APSD) that includes only a pure particle mode; converting the aerosol particle size distribution to its corresponding hydrosol particle size distribution (HPSD) based on a correction function using standard particle data; and calculating the particle size distribution and concentration of an original liquid sample by applying a dilution factor (DF).

In the hydrosol monitoring method according to an example embodiment, the aerosol size distribution (ASD) data may be acquired by aerosolizing a liquid sample through an atomizer and by measuring the same with a scanning mobility particle sizer (SMPS).

In the hydrosol monitoring method according to an example embodiment, the identifying may include determining the boundary size between the nonvolatile residue mode and the particle mode by evaluating the change in slope sign of lognormal fitted distribution.

The hydrosol monitoring method according to an example embodiment may further include validating the reliability of the liquid particle monitoring system by evaluating the consistency of the results measured at various dilution factors.

In the hydrosol monitoring method according to an example embodiment, the correction function may include a coefficient that is defined by log-log linear relationship and varies according to a particle size.

According to some example embodiments, a liquid particle monitoring system of the present invention may enable accurate analysis for a pure particle mode by effectively identifying and removing a nonvolatile residue (NVR) mode from aerosol measurement data.

According to some example embodiments, it is possible to accurately identify and separate each mode even in a complex polydisperse particle system through multimodal lognormal fitting technology.

According to some example embodiments, it is possible to enable reliable conversion from the aerosol size distribution to the hydrosol size distribution through a systematic correction using a standard polystyrene latex (PSL) nanosphere.

According to some example embodiments, it is possible to consistently restore the hydrosol distribution and concentration of an original sample from sample data measured at various dilution factors (DFs).

According to some example embodiments, it is possible to overcome the limitations found in the existing optical-based hydrosol measurement methods (LPC, DLS), and to provide excellent accuracy, particularly, in analyzing abrasive particles around 100 nm.

According to some example embodiments, it may be utilized as a high-resolution, high-reliability analysis tool for particle size distribution monitoring of an industrial colloidal systems, such as chemical mechanical polishing (CMP) slurry.

According to some example embodiments, it is possible to enable particle size distribution analysis that is less dependent on the material properties for particles of various materials, such as silica and ceria abrasives.

According to some example embodiments, it is possible to improve measurement accuracy by accurately calculating the representative average particle diameter and by applying an optimized correction function based on this.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

Embodiments will be described in more detail with regard to the figures, wherein like reference numerals refer to like parts throughout the various figures unless otherwise specified, and wherein:

FIG. 1 is a configuration diagram of a liquid particle monitoring system according to an example embodiment;

FIG. 2 illustrates an aerosol generation process and nonvolatile residue formation according to an example embodiment;

FIG. 3 illustrates an experimental device configuration and a basic mechanism of particle classification and counting using a scanning mobility particle sizer (SMPS) according to an example embodiment;

FIGS. 4A to 4E illustrate the aerosol size distribution results of monodisperse polystyrene latex nanoparticles measured with an atomizer-scanning mobility particle sizer according to an example embodiment;

FIG. 5 illustrates the measurement results of polydisperse samples including 50 nm, 200 nm, and 500 nm polystyrene latex according to an example embodiment;

FIG. 6 illustrates correlation curves between the hydrosol concentration and the aerosol concentration based on the polydisperse measurement results including the polystyrene latex (PSL) nanosphere 50 nm, 200 nm, and 500 nm measurement results according to an example embodiment;

FIGS. 7A to 7C illustrate correlation and processing method for converting aerosol measurement data to hydrosol particle data in a liquid particle monitoring system according to an example embodiment;

FIGS. 8A to 8F illustrate a multimodal lognormal fitting and nonvolatile residue classification process performed through a liquid particle monitoring system according to an example embodiment;

FIGS. 9A to 9D are flowcharts for describing NVR removal and particle separation, hydrosol-aerosol correlation, and aerosol-to-hydrosol conversion in a liquid particle monitoring system according to an example embodiment;

FIG. 10 illustrates a comparison between the results of scanning mobility particle sizer measured aerosol size distribution (ASD) and treated hydrosol particle size distribution (HPSD) at three different dilution factors (DFs) measured through a liquid particle monitoring system and the results of dynamic light scattering (DLS) intensity measurement according to an example embodiment; and

FIG. 11 illustrates the results of comparing the concentration of a DF corrected original sample and the hydrosol number concentration (NHP) of a diluted sample calculated through a liquid particle monitoring system according to an example embodiment.

### DETAILED DESCRIPTION

The specific structural or functional descriptions of example embodiments according to the concept of the present invention described herein are merely intended for the purpose of describing the example embodiments according to the concept of the present invention, and the example embodiments according to the concept of the present invention may be implemented in various forms and are not construed as limited to the example embodiments described herein.

Various modifications and various forms may be made to the example embodiments according to the concept of the present invention and thus, the example embodiments are illustrated in the drawings and described in detail through the present specification. However, it should be understood that the example embodiments according to the concept of the present invention are not construed as limited to specific implementations and should be understood to include all changes, equivalents, and replacements within the idea and the technical scope of the present invention.

Although terms of “first,” “second,” and the like are used to explain various components, the components are not limited to such terms. These terms are used only to distinguish one component from another component. For example, a first component may be referred to as a second component, or similarly, the second component may be referred to as the first component without departing from the scope according to the concept of the present invention.

When it is mentioned that one component is “connected” or “accessed” to another component, it may be understood that the one component is directly connected or accessed to the other component or that still other component is interposed between the two components. In addition, when it is described that one component is “directly connected” or “directly accessed” to another component, it should be understood that still other component is absent therebetween. Likewise, expressions describing relationships between components, for example, “between” and “immediately between” and “immediately adjacent to” may also be construed as described in the foregoing.

The terminology used herein is for the purpose of describing particular example embodiments only and is not to be limiting of the present invention. As used herein, the singular forms “a,” “an,” and “the” are intended to include the plural forms as well, unless the context clearly indicates otherwise. It will be further understood that the terms “comprises/includes” or “has,” when used in this specification, specify the presence of stated features, integers, stages, operations, components, parts, or combinations thereof, but do not preclude the presence or addition of one or more other features, integers, stages, operations, components, parts, or combinations thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art, and are not to be construed as an ideal or excessively formal meaning unless otherwise defined herein.

Hereinafter, example embodiments will be described in detail with reference to the accompanying drawings. However, the scope of the claims is not limited to or restricted by the example embodiments. Like reference numerals presented in the respective drawings refer to like components throughout.

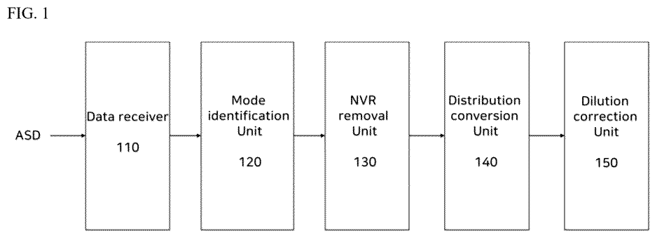

FIG. 1 is a configuration diagram of a liquid particle (hydrosol) monitoring system according to an example embodiment.

Referring to FIG. 1, a liquid particle monitoring system 100 according to an example embodiment includes a data receiver 110, a mode identification unit 120, a nonvolatile residue (NVR) removal unit 130, a distribution conversion unit 140, and a dilution correction unit 150.

The data receiver 110 receives aerosol size distribution (ASD) data that is acquired by measuring aerosolized particles

For example, the aerosol size distribution data may be acquired by aerosolizing a liquid sample through an atomizer and by measuring the same through a scanning mobility particle sizer (SMPS).

The data receiver 110 may mainly receive aerosolized measurement data of an industrial colloidal particle system, such as a chemical mechanical polishing (CMP) slurry, and the aerosol size distribution data may include information on various abrasive particles such as silica and ceria.

The mode identification unit 120 identifies a nonvolatile residue (NVR) mode and a particle mode by applying multimodal lognormal fitting to the aerosol size distribution data.

For example, the mode identification unit 120 may identify two to four modes through the multimodal lognormal fitting. Here, among fitted modes, the mode identification unit 120 may classify a mode with the geometric mean diameter less than the cutoff size as the nonvolatile residue mode, and may classify a mode with the geometric mean diameter greater than or equal to the cutoff size as the particle mode.

Also, the mode identification unit 120 may include a duplicate mode merging function of merging a plurality of particle modes within the same size range into a single particle mode. The plurality of particle modes may be merged into the single particle mode when a difference between the geometric mean diameters is less than 10% of the average diameter.

Depending on example embodiments, the mode identification unit 120 may also determine the boundary size between the nonvolatile residue mode and the particle mode by evaluating the change in slope sign of lognormal fitted distribution.

The NVR removal unit 130 generates the aerosol particle size distribution (APSD) that includes only a pure particle mode by removing the identified nonvolatile residue mode. Through this, it is possible to effectively remove interference caused by nonvolatile residues formed due to the concentration of surfactant or dissolved solute present in a liquid sample.

The NVR removal unit 130 may select the pure particle size distribution by optionally extracting only constituent elements classified as the particle mode from the multimodal fitting results.

The distribution conversion unit 140 converts the aerosol particle size distribution to its corresponding hydrosol particle size distribution (HPSD) based on a correction function using standard particle data.

For example, the distribution conversion unit 140 may use the correction function based on standard polystyrene latex (PSL) nanosphere measurement data, may calculate the representative average particle diameter ((rep) from the aerosol particle size distribution (APSD), and may determine a coefficient of the correction function according to the representative average particle diameter.

The correction function may be defined by a log-log linear relationship and may include a coefficient that varies depending on the particle size.

The liquid particle monitoring system (100) may further include a diameter calculation unit (not shown) configured to calculate a representative average particle diameter (μrep) from the aerosol particle size distribution (APSD). The diameter calculation unit may determine a particle diameter having a maximum value in the aerosol particle size distribution generated by the NVR removal unit 130 as the representative average particle diameter. The distribution conversion unit 140 may determine coefficients of the correction function according to the representative average particle diameter calculated by the diameter calculation unit.

The dilution correction unit 150 calculates the particle size distribution and concentration of an original liquid sample by applying a dilution factor (DF)

The dilution correction unit 150 may restore the hydrosol concentration of the original sample for a sample measured at a plurality of dilution factors (DFs). Depending on example embodiments, the dilution correction unit 150 may validate the reliability of the liquid particle monitoring system by evaluating the consistency of the results measured under various dilution conditions.

In particular, for slurry used for a chemical mechanical polishing (CMP) process, the dilution correction unit 150 may accurately verify the particle property of the original sample by accurately correcting the dilution factor.

The liquid particle monitoring system 100 according to an example embodiment may be effectively used to analyze the abrasive particle size and concentration of the chemical mechanical polishing (CMP) slurry, and may analyze the accurate particle size distribution even for slurry including various types of abrasives, such as silica and ceria.

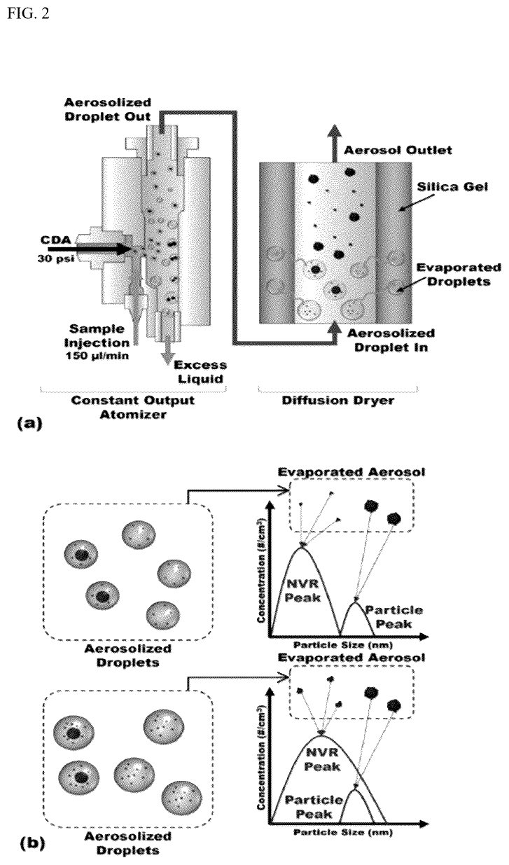

FIG. 2 illustrates an aerosol generation process and nonvolatile residue formation according to an example embodiment.

Referring to FIG. 2, (a) shows the aerosol generation process, and (b) shows nonvolatile residue (NVR) formation from surfactant in a droplet evaporation process and an example in which a particle peak and an NVR peak overlap.

Referring to (a) of FIG. 2, aerosol generation is performed through a constant output atomizer and a diffusion dryer. A liquid sample is injected into the atomizer at a constant flow rate of 150 μl/min.

The compressed and dried air is supplied through a clean and dry air (CDA) inlet at the pressure of 30 psi, and forms a high-speed jet while expanding through the orifice. Here, the liquid is injected into an atomizing section through a vertical passage and atomized.

Large droplets are removed by an impactor on the opposite wall of the jet, and excess liquid is discharged from the bottom of an atomizer assembly block. The atomized droplets, including hydrosols that have left the atomizer block, evaporate while passing through the silica gel diffusion dryer. During this process, the water droplets around particles evaporate, and aerosolized nanoparticles are generated accordingly.

Referring to (b) of FIG. 2, a liquid solution contains surfactant (e.g., cationic polymer and anionic polymer), which is a chemical component that prevents particles from aggregating within the liquid. When the originally empty droplets without solid particles evaporate, this surfactant is concentrated to form nonvolatile residue (NVR).

When the population of aerosolized particles is dominated by NVR rather than target solid particles due to an inadequate dilution factor, the formed NVR particle peak may overlap the target particle peak, causing interference.

An upper graph shown in (b) of FIG. 2 shows a case in which the NVR peak is greater than the particle peak, and a lower graph shown in (b) of FIG. 2 shows a case in which the NVR peak and the particle peak partially overlap, but are relatively distinguishable. To minimize this NVR interference, it is important to remove large droplets through impaction in the aerosol generation process and to separate the NVR peak and the particle peak by optimizing the dilution factor of the sample.

The mode identification unit 120 and the NVR removal unit 130 of the present invention may acquire the pure particle size distribution by effectively distinguishing between the NVR peak and the particle peak, and by removing the NVR peak.

The liquid particle monitoring system 100 according to an example embodiment may derive the accurate hydrosol particle size distribution (HPSD) by accurately identifying the nonvolatile residue mode and the particle mode through multimodal lognormal fitting and, through this, removing the influence of NVR from the aerosol particle size distribution (APSD).

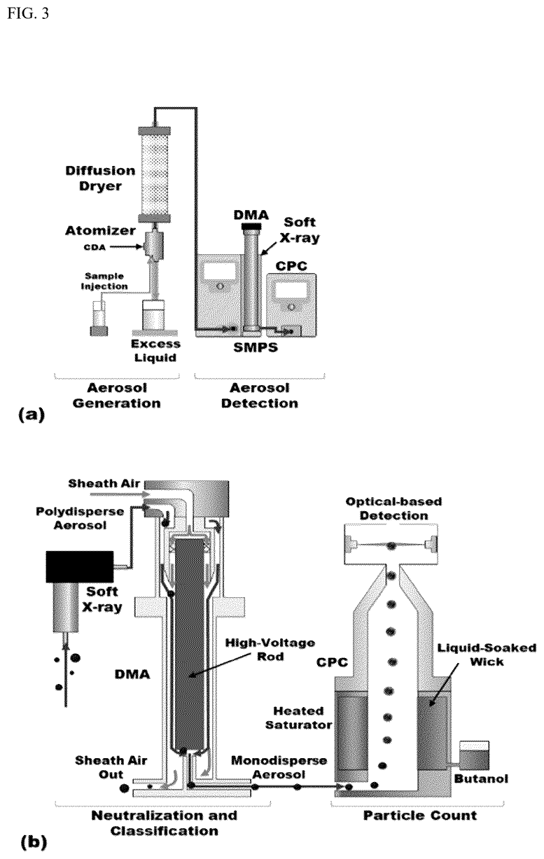

FIG. 3 illustrates an experimental device configuration and a basic mechanism of particle classification and counting using a scanning mobility particle sizer (SMPS) according to an example embodiment.

Referring to (a) of FIG. 3, an experimental device according to an example embodiment includes an aerosol generation section and an aerosol detection section. The aerosol generation section includes an atomizer, a diffusion dryer, and an excess liquid collection device.

A prepared test sample is diluted and then injected into the atomizer through an in-line pump, which enables a constant flow rate for sample injection. An atomizer block, the diffusion dryer, and an excess liquid collection bottle may be assembled vertically to minimize particle loss throughout the entire aerosolization process.

After a target liquid sample is atomized and evaporated to generate aerosol particles, they are measured by the scanning mobility particle sizer (SMPS).

Referring to (b) of FIG. 3, aerosol measurement is performed using a combination of a differential mobility analyzer (DMA) and a condensation particle counter (CPC), and bipolar charging by soft X-rays is performed prior to measurement.

The differential mobility analyzer serves to classify particles according to electrical mobility. For measurement, the scanning mobility particle sizer including an electrostatic classifier (EC), the differential mobility analyzer, and a butanol-condensation particle counter is used for measurement.

Herein, a measurement device in which the atomizer and the scanning mobility particle sizer are integrated is referred to as an atomizer-scanning mobility particle sizer (A-SMPS).

The atomizer-scanning mobility particle sizer (A-SMPS) aerosolizes hydrosols within a liquid solution and measures the aerosol concentration. The atomizer is more advantageous than an electrospray aerosol generator (EAG) due to the existing method of sample injection and the ability to inject target particles in-line.

After aerosols are generated, they are directly introduced into an electrostatic classifier to control the sheath air and high-voltage rod as shown in (b) of FIG. 3.

The differential mobility analyzer classifies monodisperse particles among polydisperse particles, and the condensation particle counter counts the number concentration of classified monodisperse particles.

In an example embodiment, a scan time is set to 182 seconds for the wide particle size measurement range, and aerosol and sheath flow rates within the differential mobility analyzer are set to 1.0 and 2.5 L/min, respectively. Through this experimental configuration, the data receiver 110 of the liquid particle monitoring system 100 according to an example embodiment may accurately receive the aerosol size distribution (ASD) data measured by the scanning mobility particle sizer, and may provide basic data for subsequent processing.

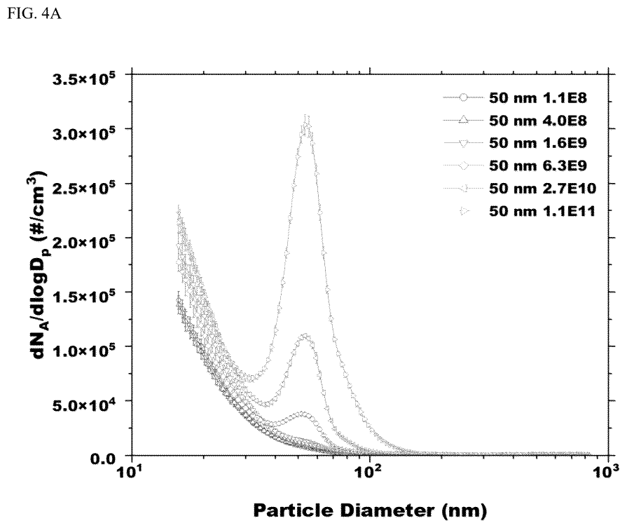

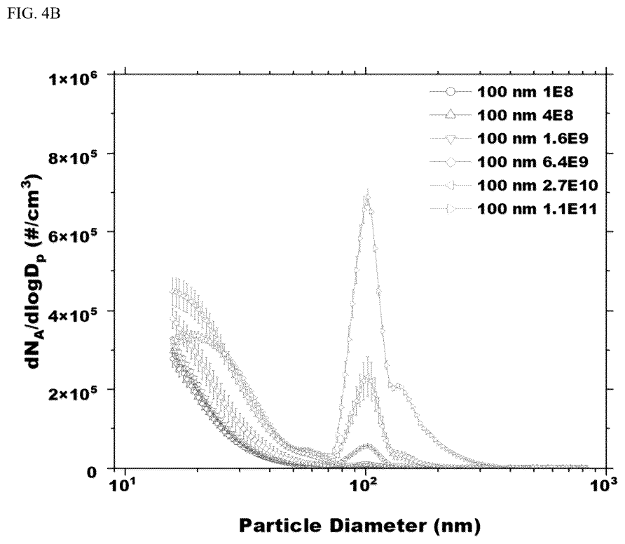

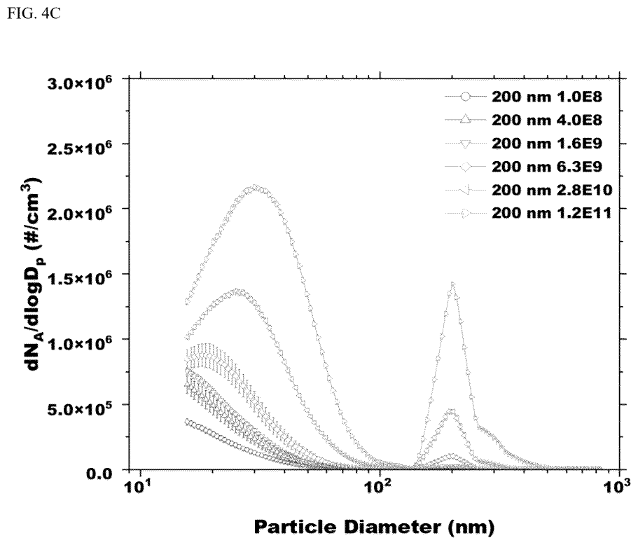

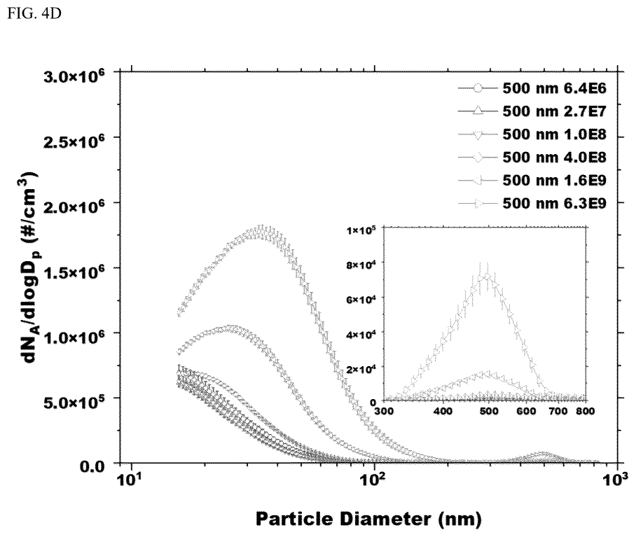

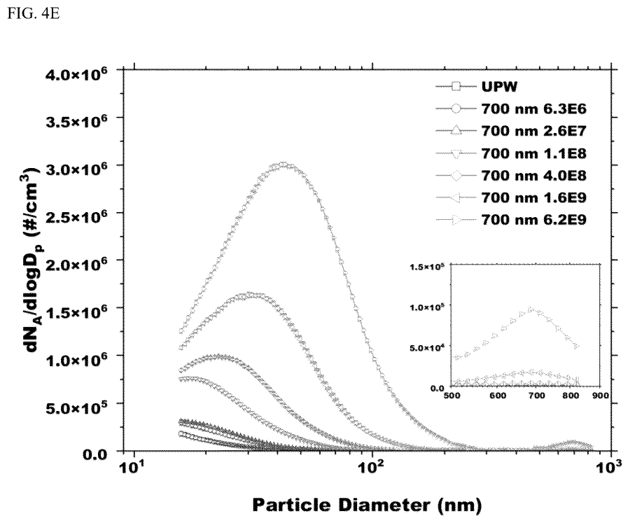

FIGS. 4A to 4E illustrate the aerosol size distribution results of monodisperse polystyrene latex nanoparticles measured with an atomizer-scanning mobility particle sizer according to an example embodiment.

FIG. 4A, FIG. 4B, FIG. 4C, FIG. D, and FIG. 4E show the measurement results for polystyrene latex nanospheres with sizes of 50 nm, 100 nm, 200 nm, 500 nm, and 700 nm, respectively,

FIGS. 4A to 4E show the results of consecutively diluting each original sample at six individual hydrosol concentration levels and sequentially measuring the same from the lowest concentration level to the highest concentration level to perform a monodisperse polystyrene latex calibration. In an aerosolization process, residual particles are typically formed, and are configured with evaporation of nonvolatile solutes from empty droplets without primary particles.

As shown in FIGS. 4A to 4E, as the particle size decreases, the probability of the overlapping particle diameter range increases and accordingly, interference due to nonvolatile residues (NVRs) becomes strong, which affects the accuracy of the measured particle size distribution.

Also, the results of FIGS. 4A to 4E show a positive correlation between the polystyrene latex particle size and the resulting nonvolatile residue mode diameter.

In detail, the correlation between the polystyrene latex particle size and the nonvolatile residue mode diameter suggests that the proportionally high surfactant concentration is involved in the manufacture of progressively larger polystyrene latex spheres. The increase in the corresponding surfactant concentration is presumed as a strategy for mitigating the enhanced condensation tendency associated with the increased specific surface area.

The lower detection limit of hydrosol concentration for each sample was also evaluated. 50 nm polystyrene latex showed the concentration less than 4.0×10⁸ (#/ml) and accordingly, showed unreliable data and the uncertain particle mode due to the residue peak overwhelming the particle peak.

Also, large particles, such as 500 nm and 700 nm polystyrene latex, had the lower concentration range for measurement compared to other sizes, and both sizes showed relatively lower distribution levels compared to small sizes of polystyrene latex, even compared to their own nonvolatile residue peaks.

500 nm and 700 nm sizes of polystyrene latex showed the lower detection limit of 4.0×10⁸ (#/ml), Consequently, the dilution factor and concentration optimization are important to accurately define the size distribution for target particles.

The results shown in FIGS. 4A to 4E illustrate aerosol size distribution (ASD) data acquired by the data receiver 110 of the liquid particle monitoring system 100 according to an example embodiment for monodisperse particles and clearly demonstrate the necessity of the mode identification unit 120 to distinguish between the nonvolatile residue mode and the particle mode.

In particular, when the particle size is small, the influence of nonvolatile residues appears to be larger, so the role of the NVR removal unit 130 of the liquid particle monitoring system 100 according to an example embodiment is important.

Also, the results of FIGS. 4A to 4E suggest that, when the distribution conversion unit 140 of the liquid particle monitoring system 100 according to an example embodiment converts the aerosol particle size distribution to the hydrosol particle size distribution, an appropriate correction function according to the particle size needs to be applied.

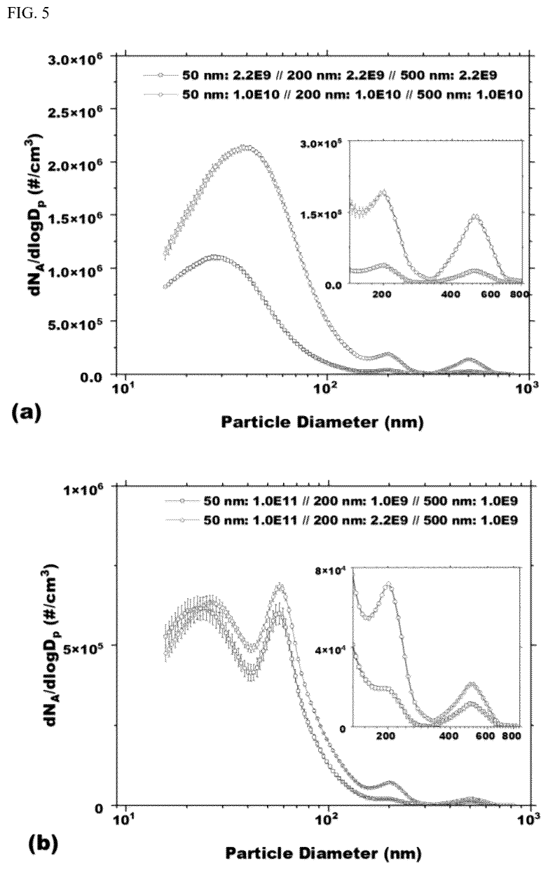

FIG. 5 illustrates the measurement results of polydisperse samples including 50 nm, 200 nm, and 500 nm polystyrene latex according to an example embodiment.

(a) of FIG. 5 shows the results when the 50 nm peak overlaps nonvolatile residues and is not identified, and (b) of FIG. 5 shows the results of correcting the concentration to make the 50 nm sample identifiable by lowering the concentration of other samples and by increasing the concentration of the 50 nm sample.

Referring to (a) of FIG. 5, the bi-modal particle size distribution of 200 nm and 500 nm polystyrene latex is shown, and it can be seen that the particle peak of 50 nm polystyrene latex is not accurately measured.

As shown in (a) of FIG. 5, due to the significantly high total surfactant amount than one used for monodisperse measurement of 50 nm polystyrene latex, the increased nonvolatile residue peak appeared to occlude the 50 nm particle peak, making it difficult to identify the same.

To solve this issue, in (b) of FIG. 5, the concentration of each particle was slightly adjusted to lower the concentration of each of 200 nm and 500 nm polystyrene latex and thereby lower the total amount of surfactant contained in a mixed sample and increase the concentration of 50 nm nanoparticles. As a result of concentration adjustment, the triple mode particle size distribution was successfully acquired as shown in (b) of FIG. 5.

The results of (a) and (b) of FIG. 5 emphasize the importance of a multimodal lognormal fitting and nonvolatile residue removal process through the liquid particle monitoring system 100 according to an example embodiment.

The mode identification unit 120 of the liquid particle monitoring system 100 according to an example embodiment needs to be able to accurately identify each size mode from polydisperse samples. In particular, the ability to distinguish between small-sized particles and the nonvolatile residue mode when they overlap is important.

Also, the NVR removal unit 130 of the liquid particle monitoring system 100 according to an example embodiment needs to effectively remove the nonvolatile residue peak caused by surfactant and to generate the aerosol particle size distribution (APSD) that includes only an actual particle mode.

Also, (a) and (b) of FIG. 5 show the importance of dilution factor and concentration optimization for each particle size when measuring polydisperse samples.

The dilution correction unit 150 of the liquid particle monitoring system 100 according to an example embodiment needs to be able to reconstruct the consistent property of the original sample under various dilution conditions and to accurately calculate the relative concentration of each particle mode in polydisperse samples. In particular, for a sample with high surfactant concentration, appropriate dilution facilitates distinguishment between nonvolatile residue and particle peaks.

The liquid particle monitoring system 100 according to an example embodiment establishes the basis for accurately analyzing the particle size distribution in various industrial application fields by providing the ability to accurately identify and analyze each particle mode even in complex polydisperse samples as shown in FIG. 5.

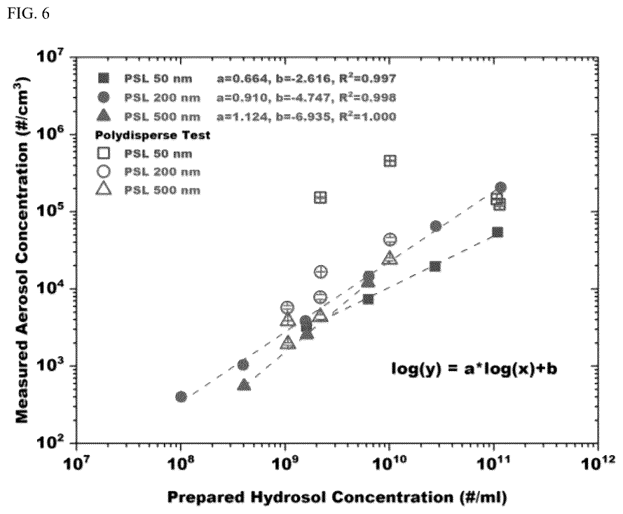

FIG. 6 illustrates correlation curves between the hydrosol concentration and the aerosol concentration based on the polydisperse measurement results including the measurement results of polystyrene latex (PSL) nanospheres 50 nm, 200 nm, and 500 nm according to an example embodiment.

Referring to FIG. 6, it can be seen that the proportional correlation between measured aerosol concentrations to the prepared hydrosol concentration is acquired by curve fitting in the form of log(y)=a*log(x)+b.

In detail, the graph shows the correlation between the hydrosol concentration and the aerosol concentration acquired by measuring 50 nm, 200 nm, and 500 nm polystyrene latex monodisperse particles.

In the graph of FIG. 6, filled symbols (▪, ●, ▴) represent the results of measuring monodisperse particles, and empty symbols (□, ◯, Δ) represent the results of measuring polydisperse particles.

Also, as shown in FIG. 6, 50 nm polystyrene latex shows the curve fitting results of a=0.664, b=−2.616, and R²−0.997, 200 nm polystyrene latex shows the results of a=0.910, b=−4.747, and R²=0.998, and 500 nm polystyrene latex shows the results of a=1.124, b=−6.935, and R²=1.000.

These high R² values indicate the strong correlation between the hydrosol concentration and the aerosol concentration.

Among the measurement results of polydisperse samples indicated with the empty symbols in FIG. 6, two outliers are outside the fitting line in the polydisperse results of 50 nm polystyrene latex.

These outliers are present since the 50 nm monodisperse particle peak is greatly obscured by the nonvolatile residue peak formed with the high surfactant concentration of larger particles (200 nm and 500 nm polystyrene latex).

Except for the two outliers, all the results show the reliably correlated results on the curve fitting lines acquired from the monodisperse polystyrene latex test, which represents that the atomizer-scanning mobility particle sizer (A-SMPS) produces the reliable results for multimodal particle size distribution measurement.

The results of FIG. 6 serve as the basis of a correction function that may be used by the distribution conversion unit 140 of the liquid particle monitoring system 100 according to an example embodiment to convert the aerosol particle size distribution to the liquid particle size distribution.

The log-log linear relationship with different coefficients (a, b) for each particle size is established, and this correction function may apply different coefficients according to the representative average particle diameter (μᵣₑₚ).

Also, the results shown in FIG. 6 demonstrate that concentration information for each particle size may be accurately extracted from polydisperse sample measurement, and confirm that, after the interference of nonvolatile residues is removed, the concentration for each particle size may be reliably measured from a sample in which various sizes of particles are mixed.

This function becomes possible through the effective operation of the NVR removal unit 130 and the distribution conversion unit 140 of the liquid particle monitoring system 100 according to an example embodiment.

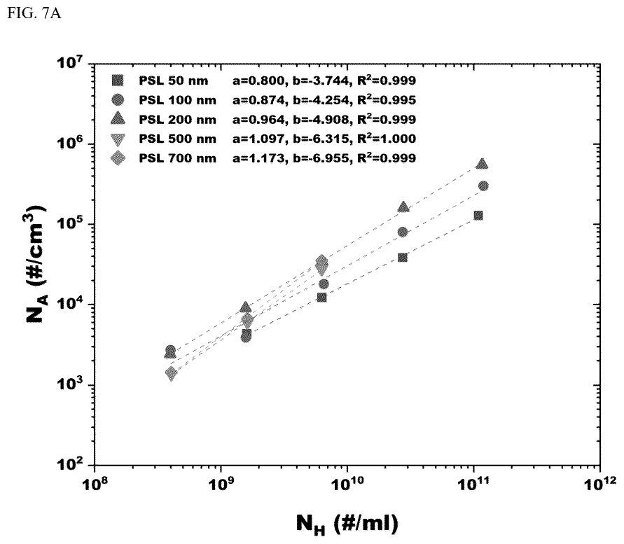

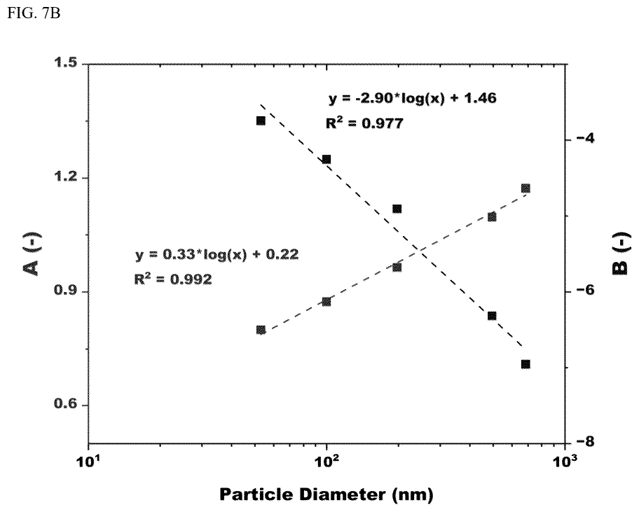

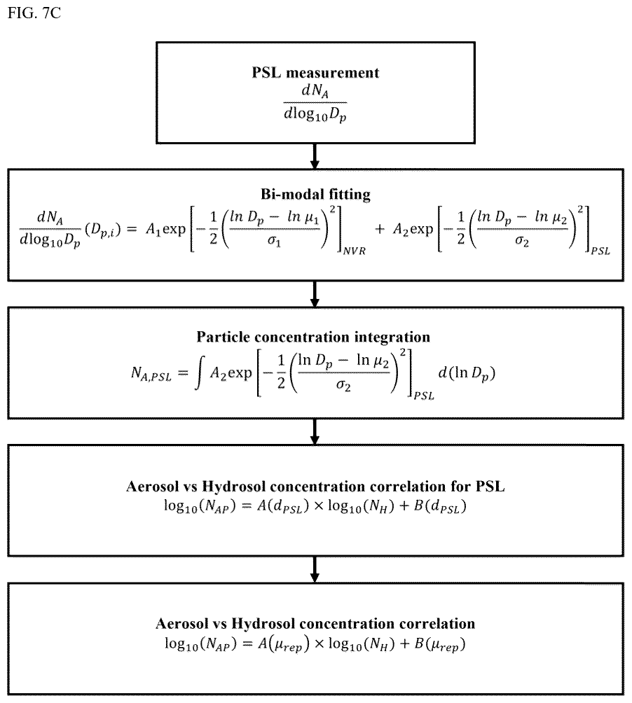

FIGS. 7A to 7C illustrate correlation and processing method for converting aerosol measurement data to hydrosol particle data in a liquid particle monitoring system according to an example embodiment.

Referring to FIG. 7A, the distribution conversion unit 140 of the liquid particle monitoring system 100 according to an example embodiment may derive the correlation between the aerosol particle number concentration (N_{A}) acquired by bi-modal fitting and the prepared hydrosol particle number concentration (N_{H}) in a log-log coordinate system, for polystyrene latex nanospheres of various sizes (50 nm, 100 nm, 200 nm, 500 nm, and 700 nm).

As shown in FIG. 7A, the correlation for each particle size shows a very high coefficient of determination (R²), which proves the reliability of a conversion process performed by the distribution conversion unit 140.

In detail, coefficient values are a=0.800, b=−3.744, and R²-0.999 for 50 nm polystyrene latex, coefficient values are a=0.874, b=−4.254, and R²-0.995 for 100 nm, coefficients values are a=0.964, b=−4.908, and R²-0.999 for 200 nm, coefficients values are a=1.097, b=−6.315, and R²=1.000 for 500 nm, and coefficients values are a=1.173, b=−6.955, and R²-0.999 for 700 nm.

Referring to FIG. 7B, the distribution conversion unit 140 of the liquid particle monitoring system 100 according to an example embodiment may systematize the change pattern of values of coefficients A and B of a conversion function according to the average particle diameter.

The coefficient A (left y-axis) increases with the relationship of y=0.33 log(x)+0.22 (R²=0.992) as the particle diameter increases, and the coefficient B (right y-axis) decreases with the relationship of y=−2.90 log(x)+1.46 (R²=0.977) as the particle diameter increases. This systematic change pattern of coefficient allows the distribution conversion unit 140 to selectively apply an optimized conversion function to particles of various sizes.

Referring to FIG. 7C, a data processing process of the liquid particle monitoring system 100 according to an example embodiment is illustrated step by step.

Initially, the data receiver 110 of the liquid particle monitoring system 100 according to an example embodiment receives aerosol size distribution (dN_{A}/d log₁₀ Dₚ) data of polystyrene latex nanospheres measured by the scanning mobility particle sizer.

Then, the mode identification unit 120 of the liquid particle monitoring system 100 according to an example embodiment identifies a nonvolatile residue mode and a particle mode from the aerosol size distribution measured through bi-modal lognormal fitting as shown in Equation 1 below.

$$\frac{{dN}_{A}}{d {log}_{10} {D}_{p}} ( {D}_{p , i} ) = {A}_{1} {exp [ - \frac{1}{2} {( \frac{ln {D}_{p} - ln {μ}_{1}}{{σ}_{1}} )}^{2} ]}_{NVR} + {A}_{2} {exp [ - \frac{1}{2} {( \frac{ln {D}_{p} - ln {μ}_{2}}{{σ}_{2}} )}^{2} ]}_{PSL} \qquad [ Equation 1 ]$$

In Equation 1 above, dNA/d log₁₀ Dp denotes the aerosol size distribution according to the particle diameter, and D_{p,i} denotes an i^{th} particle diameter channel. A₁ and A₂ denote the amplitude of nonvolatile residue (NVR) mode and the amplitude of polystyrene latex (PSL) particle mode, respectively. Also, μ₁ and μ₂ denote the geometric mean diameter of the nonvolatile residue mode and the geometric mean diameter of the particle mode, respectively, and σ₁ and σ₂ denote the geometric standard deviation of the nonvolatile residue mode and the geometric standard deviation of the particle mode, respectively. The subscript NVR denotes the nonvolatile residue mode, and PSL denotes the polystyrene latex particle mode. Equation 1 represents that the measured aerosol size distribution includes two lognormal distributions of the nonvolatile residue mode and the particle mode.

Then, the NVR removal unit 130 of the liquid particle monitoring system 100 according to an example embodiment integrates only the separated particle mode and calculates the aerosol particle number concentration with nonvolatile residues removed as shown in Equation 2.

$${N}_{A , PSL} = \int {A}_{2} {exp [ - \frac{1}{2} {( \frac{ln {D}_{p} - ln {μ}_{2}}{{σ}_{2}} )}^{2} ]}_{PSL} d ( ln {D}_{p} ) \qquad [ Equation 2 ]$$

In Equation 2 above, N_{A,PSL} denotes the aerosol particle number concentration of polystyrene latex nanospheres with nonvolatile residues removed. The integration symbol (∫) denotes integration over the entire particle diameter range, and d(ln Dₚ) denotes the slight change in the log scale particle diameter. Equation 2 represents that the total particle number concentration is calculated by integrating only the particle mode part separated from Equation 1.

Then, the distribution conversion unit 140 of the liquid particle monitoring system 100 according to an example embodiment establishes the correlation between the aerosol concentration and the hydrosol concentration for a specific particle size (d_{PSL}) as shown in Equation 3.

log₁₀(N_{A,PSL})=A(d_{PSL})×log₁₀(N_{H})+B(d_{PSL}). [Equation 3]

In Equation 3 above, A(d_{PSL}) and B(d_{PSL}) are coefficients that denote slope and intercept of the log-log linear relationship according to the specific particle size (d_{PSL}), respectively. N_{H} denotes the prepared hydrosol number concentration. Equation 3 shows the correlation between the aerosol particle number concentration and the hydrosol particle number concentration for polystyrene latex particles of a specific size as the linear relationship in the log-log coordinate system.

Then, the distribution conversion unit 140 of the liquid particle monitoring system 100 according to an example embodiment may implement a generalized conversion equation using the representative average particle diameter (μᵣₑₚ) as Equation 4 and may apply the same to an unknown sample that contains particles of various sizes.

log₁₀(N_{AP})=A(μᵣₑₚ)×log₁₀(N_{HP})+B(μᵣₑₚ) [Equation 4]

In Equation 4 above, N_{AP} denotes the aerosol particle number concentration with nonvolatile residues removed, and N_{HP} denotes the hydrosol particle number concentration. μᵣₑₚ refers to the representative average particle diameter and denotes the particle diameter having the maximum value in the aerosol particle size distribution. A(μᵣₑₚ) and B(μᵣₑₚ) denote coefficients of the conversion function that are determined according to the representative average particle diameter. Equation 4 represents a conversion equation that is applicable to an unknown sample containing particles of various sizes by generalizing Equation 3.

The liquid particle monitoring system 100 according to an example embodiment effectively drives the accurate hydrosol particle size distribution and concentration from aerosol measurement data through the stepwise data processing process from Equation 1 to Equation 4 above.

In particular, the correlation and the conversion function shown in FIGS. 7A to 7C demonstrate that the distribution conversion unit 140 and the dilution correction unit 150 may accurately restore the liquid particle (hydrosol) property of the original sample even for samples measured at various dilution factors (DFs).

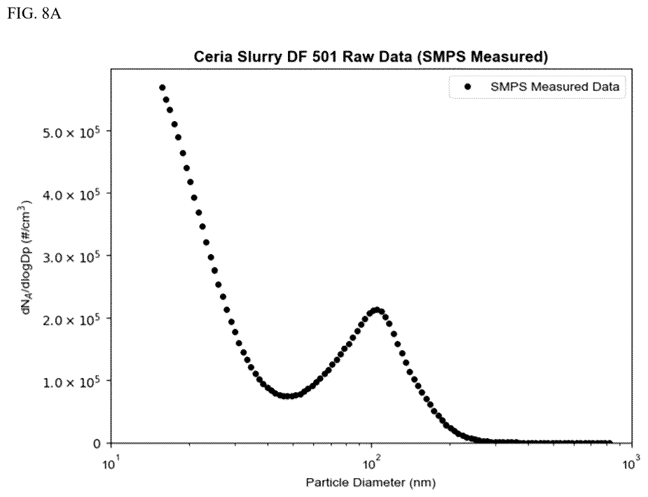

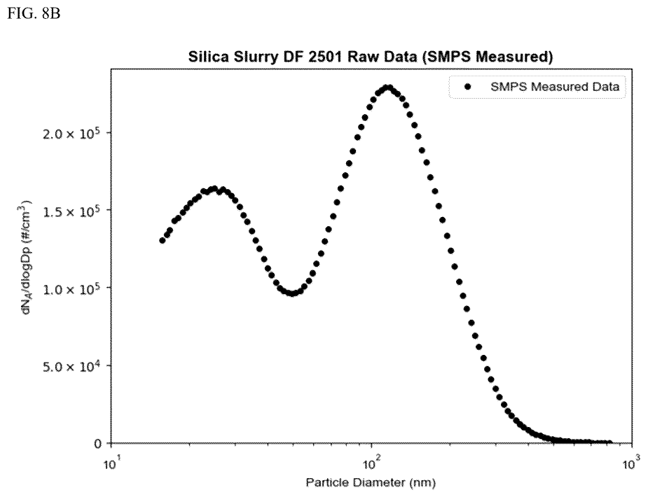

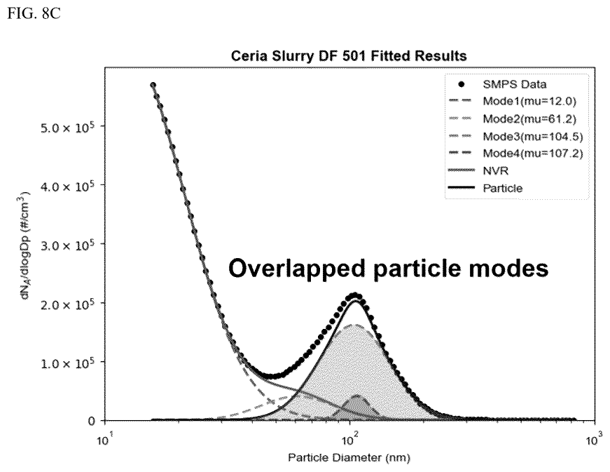

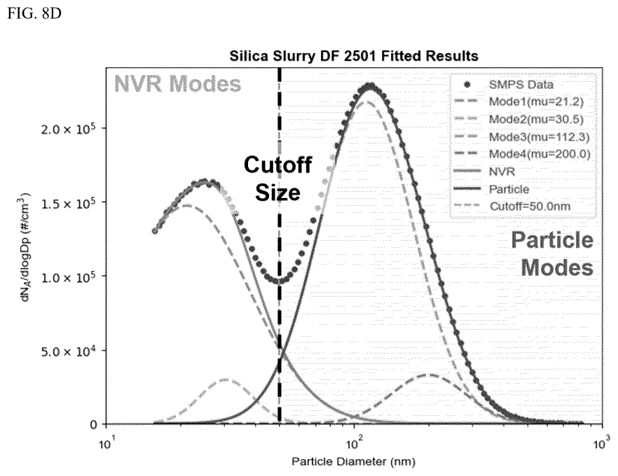

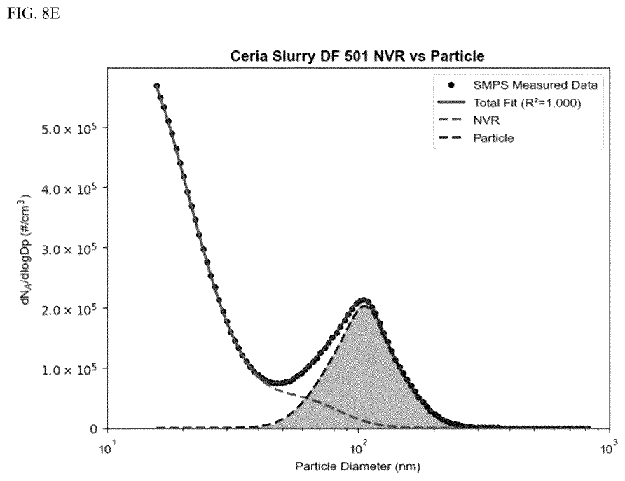

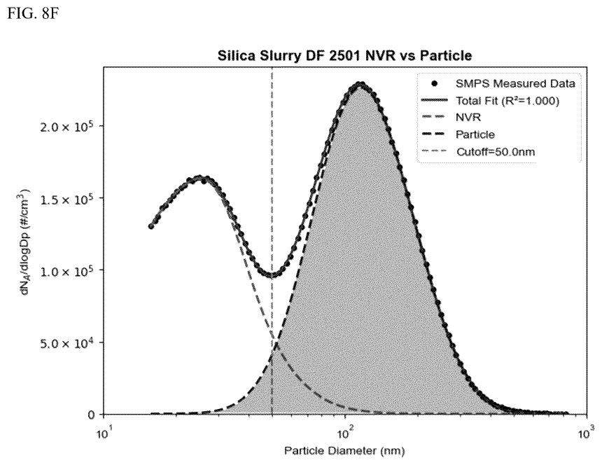

FIGS. 8A to 8F illustrate a multimodal lognormal fitting and nonvolatile residue classification process performed through the mode identification unit 120 and the NVR removal unit 130 of the liquid particle monitoring system 100 according to an example embodiment.

FIGS. 8A to 8F illustrate two cases. FIGS. 8A, 8C, and 8E illustrate a case in which overlapping final modes are merged into a single mode (hereinafter, Case 1), and FIGS. 8B, 8D, and 8F illustrate a case in which the slope-based cutoff size is applied to clearly separated final modes (hereinafter, Case 2).

Referring to FIGS. 8A and 8B, raw data measured by the data receiver 110 with a scanning mobility particle sizer (SMPS measured raw data) is illustrated. FIG. 8A shows the measurements results of a ceria slurry DF 501 sample, and FIG. 8B shows the measurement results of a silica slurry DF 2501 sample.

Referring to FIGS. 8C and 8D, mode fitting results for particle separation performed by the mode identification unit 120 are illustrated. In FIG. 8C, overlapped particle modes are observed from the ceria slurry results. In FIG. 8D, clearly separated modes and slope-based cutoff size are shown in the silica slurry results.

Depending on example embodiments, the mode identification unit 120 may fit the measured aerosol size distribution to a multimodal lognormal function as shown in Equation 5.

$${F}_{k} ( {D}_{p , i} ) = {\sum }_{j = 1}^{k} {A}_{j} {exp [ - \frac{1}{2} {( \frac{ln ( {D}_{p} ) - ln ( {μ}_{j} )}{{σ}_{j}} )}^{2} ]}_{k = 2 … 4} \qquad [ Equation 5 ]$$

In Equation 5 above, k denotes the number of modes, ranging from 2 to 4, and each lognormal component has the amplitude Aⱼ, the geometric mean diameter μⱼ, and the geometric standard deviation σⱼ.

In Equation 5 above, Fₖ(D_{p,i}) denotes the aerosol size distribution function fitted with k lognormal modes. j denotes an index of each lognormal mode and has a value ranging from 1 to k. Here, k denotes the number of modes, ranging from 2 to 4. Σ is a symbol that represents the summation of all modes, and k=2 . . . 4 indicates that this fitting considers minimum two modes to maximum four modes. Equation 5 above represents the multimodal fitting function that decomposes the complex multimodal aerosol size distribution into a plurality of lognormal components.

Referring to FIGS. 8E and 8F, the results of distinguishing between the nonvolatile residue mode and the particle mode through the NVR removal unit 130 (NVR vs Particle) is illustrated.

In the case of ceria slurry in FIG. 8E, it can be seen that μ₃ and μ₄ modes are overlapped and merged into a single particle mode, that is, merged particle modes. In the case of silica slurry in FIG. 8F, it can be seen that four separated modes are present and the slope-based cutoff is applied.

Depending on example embodiments, the mode identification unit 120 may determine whether there is overlap among fitted modes as in Equation 6.

$$\frac{\vert {μ}_{4} - {μ}_{3} \vert}{( {μ}_{4} + {μ}_{3} ) / 2} < 0.1 \qquad [ Equation 6 ]$$

In Equation 6 above, μ₃ and μ₄ denote geometric mean diameters of third and fourth lognormal modes acquired in multimodal fitting, respectively. |μ₄−μ₃| in the numerator denotes the absolute value of the difference between the geometric mean diameters of the two modes, and (μ₄+μ₃)/2 in the denominator denotes the average value of the geometric mean diameters of the two modes. Equation 6 provides a criterion for determining the two modes as the overlapped modes when the relative difference between the two modes is less than 10%.

If Equation 6 above is satisfied, that is, if the difference between the geometric mean diameters is less than 10% of the average diameter, the mode identification unit 120 merges the corresponding modes into a single particle mode. This determination provides the practical compromise between the numerical variation of the fitted parameter and the physical indistinguishability of peaks in the corresponding size range.

Also, depending on example embodiments, if there is no overlapping mode, or if the number of modes k is determined to be less than 4, the mode identification unit 120 may evaluate the change in the slope sign of the lognormal fitted distribution and may determine the boundary size (D_{p, Cutoff}) between the nonvolatile residue mode and the particle mode as shown in Equation 7.

$${Slope}_{i} = \frac{{F}_{k} ( {D}_{p , i + 1} ) - {F}_{k} ( {D}_{p , i} )}{{log}_{10} ( {D}_{p , i + 1} ) - {log}_{10} ( {D}_{p , i} )} \qquad [ Equation 7 ]$$

In Equation 7 above, Slopeᵢ denotes the slope of fitted distribution curve in an i^{th} channel. Fₖ(D_{p,i+1}) and Fₖ(D_{p,i}) denote fitted distribution function values in (i+1)-th and i^{th} particle diameter channels, respectively. log₁₀(D_{p,i+1}) and log₁₀(D_{p,i}) denote log values of (i+1)-th and i^{th} particle diameters, respectively. Equation 7 defines a method of calculating the slope between two adjacent points of the fitted distribution curve.

In Equation 7 above, the slope for each channel i may be calculated and a point that satisfies the condition as shown in Equation 8 below may be set as cutoff.

{Slope₁₋₁<0}Λ/{(Slopeᵢ₋₁×Slopeᵢ)<0}⇒D_{p,i}=D_{p,Cutoff} [Equation 8]

In Equation 8 above, A denotes a logical ‘AND’ operator, and ⇒ denotes a logical implication. D_{p,Cutoff} denotes the cutoff diameter used to distinguish between the nonvolatile residue mode and the particle mode. Equation 8 defines the condition that, when the slope in the (i−1)-th channel is negative and the product of slopes of (i−1)-th and i^{th} channels is negative, the i^{th} particle diameter is set as the cutoff diameter. This represents a method of finding a point at which the slope of the fitted distribution curve changes from negative to positive.

Also, depending on example embodiments, based on the cutoff size (D_{p,Cutoff}), the mode identification unit 120 may classify each mode as the nonvolatile residue mode or the particle mode according to conditions of Equation 9 and Equation 10 below.

μⱼ<D_{p,Cutoff}⇒j∈J_{NVR} (nonvolatile residue mode) [Equation 9]

μⱼ≥D_{p,Cutoff}⇒j∈J_{Particle} (particle mode) [Equation 10]

In Equation 9 above, J_{NVR} denotes a set of modes classified as the nonvolatile residue mode. Equation 9 defines that, when the geometric mean diameter (μⱼ) of the j^{th} mode is less than the cutoff diameter (D_{p,Cutoff}), the corresponding mode is classified as the nonvolatile residue mode.

Also, in Equation 10 above, J_{Particle} denotes a set of modes classified as the particle mode. Equation 10 defines that, when the geometric mean diameter (μⱼ) of the j^{th} mode is greater than or equal to the cutoff diameter (D_{p,Cutoff}), the corresponding mode is classified as the particle mode.

Also, depending on example embodiments, the NVR removal unit 130 may generate the aerosol particle size distribution (APSD) with nonvolatile residues removed as in Equation 11 below by summing only modes classified as the particle mode.

$$\frac{{dN}_{AP}}{d {log}_{10} {D}_{p}} ( {D}_{p , i} ) = {\sum }_{j ∈ {𝒥}_{Particle}} {A}_{j} exp [ - \frac{1}{2} {( \frac{ln ( {D}_{p} ) - ln ( {μ}_{j} )}{{σ}_{j}} )}^{2} ] \qquad [ Equation 11 ]$$

In Equation 11 above, dN_{AP}/d log₁₀ Dₚ denotes the aerosol particle size distribution with nonvolatile residues removed. Σj∈J_{Particle} denotes the summation over all j classified as the particle mode. Equation 11 defines a method of generating the pure aerosol particle size distribution with nonvolatile residues removed by summing only lognormal modes classified as the particle mode.

Through the results shown in FIGS. 8A to 8F, it can be seen that the mode identification unit 120 and the NVR removal unit 130 of the liquid particle monitoring system 100 may effectively distinguish and process the nonvolatile residues and the particle mode from the aerosol size distribution of various slurry samples.

The liquid particle monitoring system 100 according to an example embodiment may successfully merge overlapping modes of μ₃ and μ₄ into a single particle mode even in the complex distribution having four modes such as ceria slurry, and may effectively separate the nonvolatile residue mode and the particle mode using slope-based cutoff in the distribution with clearly separated modes, such as silica slurry.

The liquid particle monitoring system 100 according to an example embodiment may accurately extract only the pure particle mode from aerosol measurement data through the multimodal fitting and nonvolatile residue removal process, and may accurately analyze the hydrosol particle size distribution through the distribution conversion unit 140 and the dilution correction unit 150.

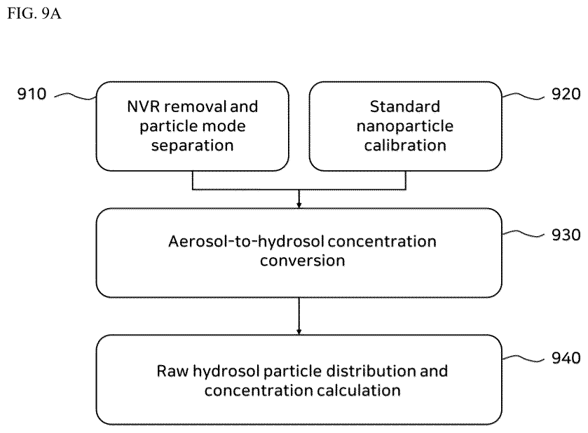

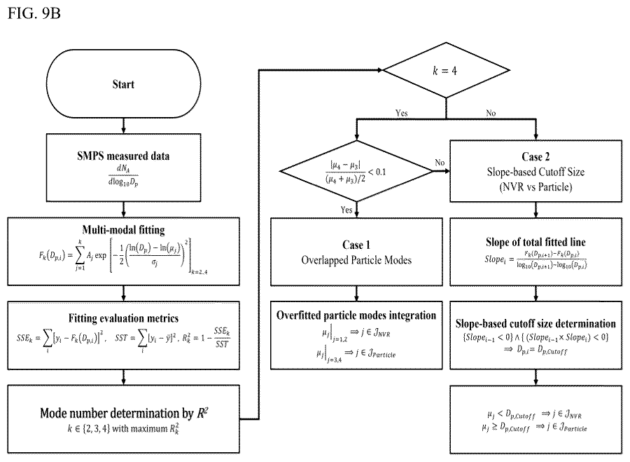

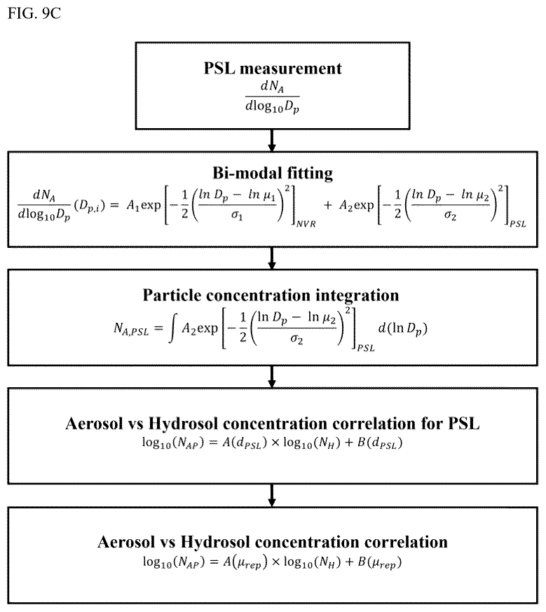

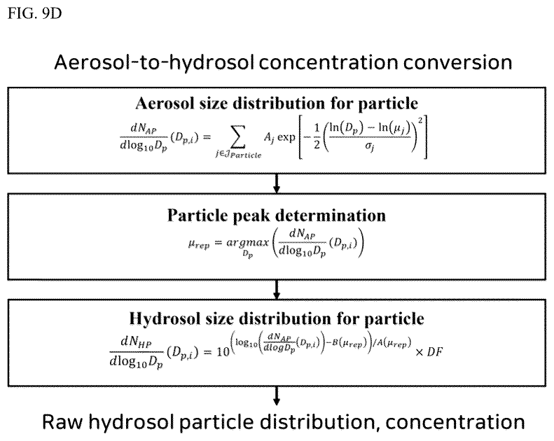

FIGS. 9A to 9D are flowcharts for describing NVR removal and particle separation, hydrosol-aerosol correlation, and aerosol-to-hydrosol conversion in a liquid particle monitoring system according to an example embodiment.

FIG. 9A schematically illustrates the overall processing flowchart of the liquid particle monitoring system 100 according to an example embodiment.

Referring to FIG. 9A, a processing process of the liquid particle monitoring system 100 largely includes three stages, for example, NVR removal and particle mode separation operation 910 and standard nanoparticle calibration operation 920, aerosol-to-hydrosol concentration conversion operation 930, and raw hydrosol particle distribution and concentration calculation operation 940.

In NVR removal and particle mode separation operation 910, the mode identification unit 120 and the NVR removal unit 130 may separate the nonvolatile residue mode and the particle mode from the aerosol size distribution and may extract only the pure particle mode.

In standard nanoparticle calibration operation 920, the distribution conversion unit 140 may establish the aerosol-hydrosol concentration correlation using standard polystyrene latex nanosphere measurement data.

Also, in aerosol-to-hydrosol concentration conversion operation 930, the distribution conversion unit 140 may convert the aerosol particle size distribution to the corresponding hydrosol particle size distribution.

Also, in raw hydrosol particle size distribution and concentration calculation operation 940, the dilution correction unit 150 may calculate the hydrosol particle size distribution and concentration of an original sample by applying a dilution factor.

FIG. 9A effectively summarizes the entire hydrosol characterization process, and each operation may be sequentially performed to derive the hydrosol particle size distribution and concentration analysis results. This processing flow conceptually shows the process sequentially performed by the data receiver 110, the mode identification unit 120, the NVR removal unit 130, the distribution conversion unit 140, and the dilution correction unit 150 of the liquid particle monitoring system 100.

FIG. 9B illustrates a detailed flowchart of an NVR removal and particle separation process of the liquid particle monitoring system 100 according to an example embodiment.

FIG. 9B may be divided into an initial data processing process on the left and a mode classification process on the right.

Initially, at a starting point, the data receiver 110 receives aerosol size distribution (dN_{A}/d log₁₀ Dp) data measured with the scanning mobility particle sizer.

Then, the mode identification unit 120 applies multimodal lognormal fitting to the received data. In detail, the mode identification unit 120 of the liquid particle monitoring system 100 according to an example embodiment may apply the above-described multimodal fitting as in Equation 5 described above to the measured data.

Then, the mode identification unit 120 of the liquid particle monitoring system 100 according to an example embodiment may determine the optimal number of modes by calculating fitting evaluation metrics. Here, the mode identification unit 120 calculates the coefficient of determination (R²) using the sum of squared error (SSE) and the total sum of squares (SST), and selects k∈{2,3,4} having maximum R².

According to the results, the flow on the right is performed and if k=4 is determined. If k=4, the mode identification unit 120 of the liquid particle monitoring system 100 may determine whether μ₃ and μ₄ overlap based on Equation 6 described above.

If Equation 6 is satisfied (Case 1), the mode identification unit 120 of the liquid particle monitoring system 100 according to an example embodiment may merge overlapping particle modes, and may classify the same as μⱼ|_{j=1,2}⇒j∈J_{NVR}, μj|_{j=3,4}⇒j∈J_{Particle}.

Also, if Equation 6 is not satisfied, or if k<4 (Case 2), the mode identification unit 120 of the liquid particle monitoring system 100 according to an example embodiment may calculate the slope of total fitted line as in Equation 7 described above.

Then, the mode identification unit 120 of the liquid particle monitoring system 100 according to an example embodiment may determine the slope-based cutoff size according to Equation 8 described above.

Then, the mode identification unit 120 of the liquid particle monitoring system 100 according to an example embodiment classifies modes according to Equation 9 and Equation 10 described above, based on the determined cutoff size.

This detailed algorithm flow clearly shows the core technology of the present invention that may accurately identify the nonvolatile residue and the particle mode even in the complex multimodal distribution.

FIG. 9C illustrates in detail a standard nanoparticle calibration and aerosol-hydrosol correlation establishment process of the liquid particle monitoring system 100 according to an example embodiment.

Referring to FIG. 9C, starting from the top of FIG. 9C, standard polystyrene latex nanosphere (PSL measurement) measurement data is received.

The distribution conversion unit 140 of the liquid particle monitoring system 100 according to an example embodiment may apply bi-modal fitting to the standard polystyrene latex nanosphere measurement data, may acquire the aerosol particle number concentration by integrating only the particle mode, and then may establish correlation between the hydrosol concentration and the aerosol concentration.

Then, a bi-modal fitting operation is performed. In this operation, Equation 12 is applied to the received PSL data.

$$\frac{{dN}_{A}}{d {log}_{10} {D}_{p}} ( {D}_{p , i} ) = {A}_{1} {exp [ - \frac{1}{2} {( \frac{ln {D}_{p} - ln {μ}_{1}}{{σ}_{1}} )}^{2} ]}_{NVR} + {A}_{2} {exp [ - \frac{1}{2} {( \frac{ln {D}_{p} - ln {μ}_{2}}{{σ}_{2}} )}^{2} ]}_{PSL} \qquad [ Equation 12 ]$$

Equation 12 above represents a bi-modal mode lognormal fitting function for standard polystyrene latex nanosphere measurement, and has the same structure as Equation 1 described above. Equation 12 is used for separation of the nonvolatile residue mode and the particle mode for standard particle data, and is applied in the calibration process.

Through Equation 12 above, the nonvolatile residue mode and the PSL particle mode may be clearly distinguished.

Then, a particle concentration integration operation is performed, and the aerosol particle number concentration is calculated using Equation 13 by integrating only the separated PSL particle mode.

$${N}_{A , PSL} = \int {A}_{2} {exp [ - \frac{1}{2} {( \frac{ln {D}_{p} - ln {μ}_{2}}{{σ}_{2}} )}^{2} ]}_{PSL} d ( ln {D}_{p} ) \qquad [ Equation 13 ]$$

Equation 13 above is used to calculate the aerosol particle number concentration by integrating only the particle mode of standard polystyrene latex nanosphere, and has the same structure as Equation 2. Equation 13 is used to derive the aerosol concentration of pure standard particles with the nonvolatile residue influence removed in the calibration process.

In a subsequent operation, the aerosol-vs-hydrosol concentration correlation for PSL is established with Equation 14. This represents the correlation for PSL particles with a specific size.

log₁₀(N_{AP})=A(d_{PSL})×log₁₀(N_{H})+B(d_{PSL}) [Equation 14]

Equation 14 above represents the correlation between the aerosol concentration and the hydrosol concentration for polystyrene latex particles of a specific size, and has the same structure as Equation 3 described above. Equation 14 defines a calibration relationship based on standard particle data.

In a last operation, this correlation is generalized and expressed as Equation 15. Here, μᵣₑₚ denotes the representative average particle diameter, which allows aerosol-to-hydrosol concentration conversion even for unknown samples containing particles of various sizes.

log₁₀(N_{AP})=A(μᵣₑₚ)×log₁₀(N_{H})+B(μᵣₑₚ) [Equation 15]

Equation 15 above represents the aerosol-hydrosol concentration correlation generalized using the representative average particle size, and has the same structure as Equation 4 described above. Equation 15 provides a conversion equation that may be applied to an unknown sample containing particles of various sizes.

This systematic calibration process relates to the core function performed by the distribution conversion unit 140, and provides the basis of converting aerosol measurement data to accurate hydrosol particle information.

FIG. 9D illustrates an aerosol-to-hydrosol conversion process of the liquid particle monitoring system 100 according to an example embodiment.

A title “Aerosol→hydrosol concentration conversion” is displayed at the top of FIG. 9D. A first operation is to generate the aerosol size distribution for particles, and the NVR removal unit 130 of the liquid particle monitoring system 100 according to an example embodiment may extract only a part classified as the particle mode and may generate the aerosol particle size distribution with nonvolatile residues removed as in Equation 11 described above.

A second operation refers to particle peak determination, and the NVR removal unit 130 of the liquid particle monitoring system 100 according to an example embodiment may calculate the representative average particle diameter (μᵣₑₚ) from the aerosol particle size distribution acquired in the particle peak determination operation, as in Equation 16.

$${μ}_{rep} = {arg max}_{{D}_{p}} ( \frac{{dN}_{AP}}{d {log}_{10} {D}_{p}} ( {D}_{p , i} ) ) \qquad [ Equation 16 ]$$

In Equation 16 above, argmax denotes an operator that finds a variable for maximizing a function value. Equation 16 defines a method of determining the particle diameter with the maximum value as the representative average particle diameter (μᵣₑₚ) in the aerosol particle size distribution (dN_{AP}/d log₁₀ Dₚ) with nonvolatile residues removed.

Then, in a third operation, the distribution conversion unit 140 and the dilution correction unit 150 of the liquid particle monitoring system 100 according to an example embodiment convert the aerosol particle size distribution to the liquid particle size distribution, and apply a dilution factor (DF) to restore the liquid particle size distribution of the original sample as in Equation 17.

$$\frac{{dN}_{HP}}{d {log}_{10} {D}_{p}} ( {D}_{p , i} ) = {10}^{( {log}_{10} ( \frac{{dN}_{AP}}{d {log}_{10} {D}_{p}} ( {D}_{p , i} ) ) - B ( {μ}_{rep} ) ) / A ( {μ}_{rep} )} \times DF \qquad [ Equation 17 ]$$

In Equation 17 above, dN_{HP}/d log₁₀ Dₚ denotes the liquid particle size distribution, and DF denotes the dilution factor. Equation 17 above defines a method of restoring the liquid particle size distribution of the original sample by converting the aerosol particle size distribution with nonvolatile residues removed to the liquid particle size distribution using conversion coefficients A(μᵣₑₚ) and B(μᵣₑₚ) according to the representative average particle diameter and by multiplying the dilution factor.

A last operation shows that the final results of the entire conversion process is the liquid particle size distribution and concentration of the original sample, as indicated with ‘Raw hydrosol particle distribution, concentration.’ The detailed conversion process of FIG. 9D clearly shows how the liquid particle monitoring system 100 derives the accurate hydrosol property from the aerosol measurement data.

The flowcharts shown in FIGS. 9A to 9D show the entire process in which the liquid particle monitoring system 100 according to an example embodiment effectively removes nonvolatile residues from aerosol measurement data and derives the accurate liquid particle size distribution through the correlation using the standard particle data.

Through this systematic data process method, the liquid particle monitoring system 100 may overcome the limitations found in the existing liquid measurement methods, and may accurately analyze the property of the original sample under various dilution conditions.

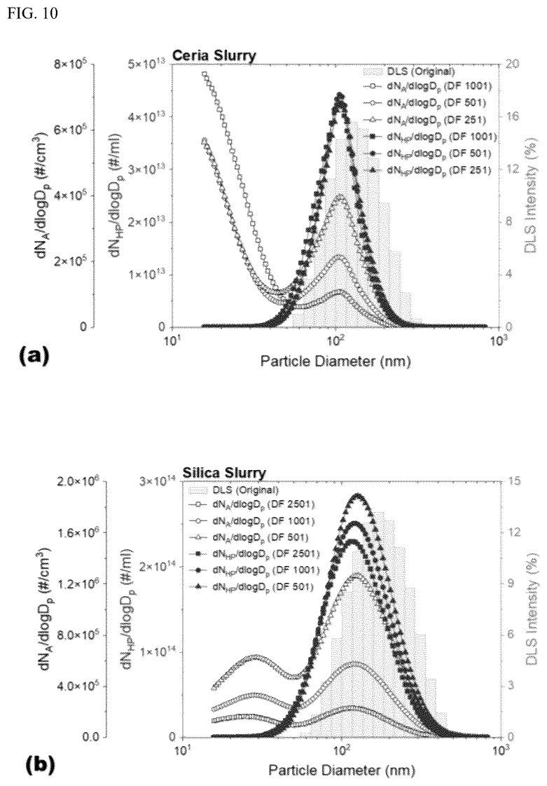

FIG. 10 illustrates a comparison between the results of scanning mobility particle sizer measured aerosol size distribution (ASD) and treated hydrosol particle size distribution (HPSD) at three different dilution factors (DFs) measured through a liquid particle monitoring system and the results of dynamic light scattering (DLS) intensity measurement according to an example embodiment.

(a) of FIG. 10 shows the results for ceria slurry, and (b) of FIG. 10 shows the results for silica slurry.

In detail, (a) of FIG. 10 shows the results of aerosol size distribution (dN_{A}/d log Dₚ, open symbols) measured and liquid particle size distribution (dN_{HP}/d log Dₚ, filled symbols) treated at three different dilution factors (DF 1001, DF 501, and DF 251) for the ceria slurry sample.

Also, histogram bars illustrated in (a) of FIG. 10 represent the results of measuring the dynamic light scattering intensity of the original sample.

Referring to (a) of FIG. 10, for ceria slurry, a prominent nonvolatile residue (NVR) mode is observed in a small diameter area of the raw aerosol size distribution measured at all three dilution factors.

However, as shown in (a) of FIG. 10, the results of the liquid particle size distribution treated through the NVR removal unit 130 and the distribution conversion unit 140 of the liquid particle monitoring system 100 according to an example embodiment show almost the same distribution with respect to all three dilution factors, and demonstrate that the dilution correction unit 150 effectively corrected the dilution factor.

The coincidence of liquid particle size distribution curves after dilution factor correction provides the reliability to the liquid particle monitoring system 100 according to an example embodiment that may accurately restore the particle distribution of the original sample even in a diluted sample.

(b) of FIG. 10 shows the results for a silica slurry sample, and the silica slurry was also measured at three different dilution factors (DF 2501, DF 1001, and DF 501), and similar to the ceria slurry, a nonvolatile residue mode is observed in a small diameter area in the aerosol size distribution.

Referring to (b) of FIG. 10, the results of the treated liquid particle size distribution show similar average diameters at three dilution factors, but a slight distribution shift and amplitude increase are observed according to an increase in concentration (i.e., decrease in DF).

The subtle change in the silica slurry shown in (b) of FIG. 10 may be attributed to an interaction between suspended particles, a slight increase in polydispersity at a more concentrated condition, or a small systematic bias in an atomization and detection process.

Nevertheless, the liquid particle monitoring system 100 still produces the consistent peak that matches the expected particle size range, which confirms the flexibility of the method disclosed herein.

Also, as shown in (b) of FIG. 10, for both the ceria slurry and the silica slurry, the results of dynamic light scattering measurements (histograms) show intensity-weighted peaks at larger particle diameters than the scanning mobility particle sizer-based HPSD.

This difference is caused by disproportional scattering contribution of known large particles in dynamic light scattering, and generally shifts the peak to the higher diameter.

However, dynamic light scattering data shows that both ceria and silica samples have major particle population in the same size range as the particle mode identified by the mode identification unit 120 after removal by the NVR removal unit 130 of the liquid particle monitoring system 100.

As shown in FIG. 10, the liquid particle monitoring system 100 according to an example embodiment may provide the consistent liquid particle size distribution at various dilution factors, and may effectively remove the interference caused by nonvolatile residues, thereby enabling the accurate property analysis of industrial hydrosol, such as chemical mechanical polishing (CMP) slurry.

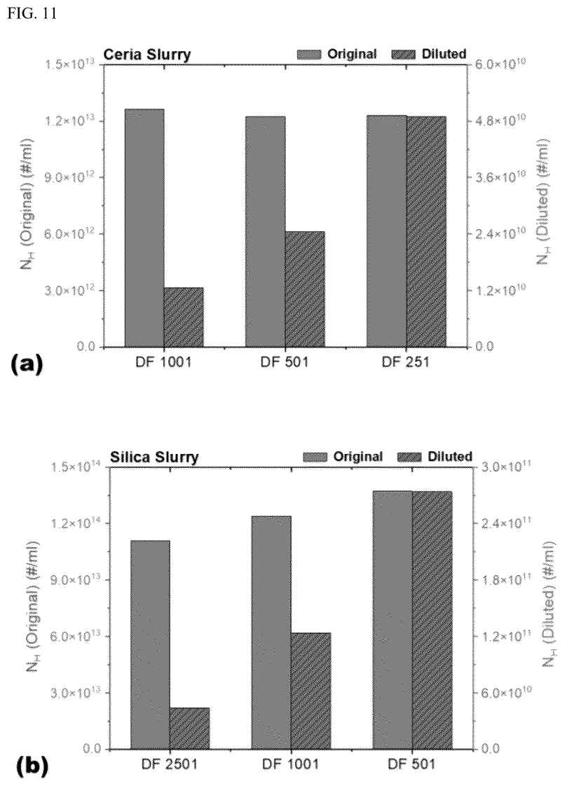

FIG. 11 illustrates the results of comparing the concentration of a DF corrected original sample and the hydrosol number concentration (NHP) of a diluted sample calculated through the dilution correction unit 150 of the liquid particle monitoring system 100 according to an example embodiment.

In detail, (a) of FIG. 11 shows the results for ceria slurry and (b) of FIG. 11 shows the results for silica slurry.

Referring to (a) of FIG. 11, for the ceria slurry, the hydrosol particle number concentrations (hatched bars) of diluted samples measured at three different dilution factors (DF 1001, DF 501, and DF 251) and the hydrosol number concentrations (solid bars) of an original sample calculated by applying a dilution factor (DF) with the dilution correction unit 150 are compared.

As shown in (a) of FIG. 11, the DF-corrected original sample particle concentrations for the ceria slurry show very similar values for all three dilution factors, which provides that the liquid particle monitoring system 100 may consistently restore the concentration of the original sample even under various dilution conditions.

In particular, for the ceria slurry, as the dilution factor decreases (i.e., as sample concentration increases), the measured concentration of the diluted sample linearly increases. Through this, the dilution correction unit 150 derives the consistent original sample concentration as about 1.2×10¹³ (#/ml).

(b) of FIG. 11 shows the measurement results for the silica slurry. The silica slurry was also measured at three different dilution factors (DF 2501, DF 1001, and DF 501), and the measured concentration of the diluted sample and the DF corrected original sample concentration are compared and illustrated.

Referring to (b) of FIG. 11, for the silica slurry, as the dilution factor decreases, the DF-corrected original sample concentration slightly increases, which is consistent with the slight change in particle distribution with the increase in concentration as observed in FIG. 10.

This slight increase in concentration of the silica slurry may be attributed to the interaction between suspended particles, the physical property of the sample, or the slight difference in an atomization process. However, the dilution factor correction results present the original sample concentration within the range of about 1.1×10¹⁴ to 1.4×10¹⁴ (#/ml), which may be considered as relatively consistent results.

The results of FIG. 11 show that the dilution correction unit 150 of the liquid particle monitoring system 100 according to an example embodiment may effectively restore the hydrosol particle concentration of the original sample from samples measured at various dilution factors.

In particular, very consistent restoration of original sample concentration is shown for the ceria slurry, and the original sample concentration within the acceptable range is derived even for the silica slurry. This dilution correction function may greatly improve practicality and flexibility of the liquid particle monitoring system 100 according to an example embodiment, in terms of characterization of a high-concentration sample such as industrial slurry.

The apparatuses described herein may be implemented using hardware components, software components, and/or combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable array (FPA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be permanently or temporarily embodied in any type of machine, component, physical equipment, virtual equipment, a computer storage medium or device, or a signal wave to be transmitted to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the above-described example embodiments may be configured in a form of program instructions performed through various computer devices and recorded in computer-readable media. The media may include, alone or in combination with program instructions, data files, data structures, and the like. The program instructions recorded in the media may be specially designed and configured for the example embodiments, or may be known and available to those skilled in the computer software art. Examples of the media include magnetic media such as hard disks, floppy disks, and magnetic tapes; optical media such as CD-ROM and DVDs; magneto-optical media such as floptical disks; and hardware devices that are configured to store program instructions, such as read-only memory (ROM), random access memory (RAM), flash memory, and the like. Examples of the program instructions include a machine language code as produced by a compiler and an advanced language code executable by a computer using an interpreter. The hardware device may be configured to operate as at least one software module, or vice versa.

Although the example embodiments are described with reference to the accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A liquid particle monitoring system comprising:
a data receiver configured to receive aerosol size distribution (ASD) data acquired through measurement of aerosolized particles;
a mode identification unit configured to identify a nonvolatile residue (NVR) mode and a particle mode by applying multimodal lognormal fitting to the aerosol size distribution data;
an NVR removal unit configured to remove the identified nonvolatile residue mode, and to generate aerosol particle size distribution (APSD) that includes only a pure particle mode;
a distribution conversion unit configured to convert the aerosol particle size distribution to its corresponding hydrosol particle size distribution (HPSD) based on a correction function using standard particle data; and
a dilution correction unit configured to calculate the particle size distribution and concentration of an original liquid sample by applying a dilution factor (DF).

2. The liquid particle monitoring system of claim 1, wherein the mode identification unit is configured to classify, as the nonvolatile residue mode, a mode of which a geometric mean diameter is less than a preset cutoff size among fitted modes, and to classify, as the particle mode, a mode of which a geometric mean diameter is greater than or equal to the cutoff size.

3. The liquid particle monitoring system of claim 1, wherein the distribution conversion unit is configured to use the correction function based on standard polystyrene latex (PSL) nanosphere measurement data.

4. The liquid particle monitoring system of claim 1, further comprising:
a diameter calculation unit configured to calculate the representative average particle diameter (μᵣₑₚ) from the aerosol particle size distribution (APSD),
wherein the distribution conversion unit is configured to determine the coefficient of the correction function according to the representative average particle diameter.

5. The liquid particle monitoring system of claim 1, wherein the dilution correction unit is configured to restore the liquid particle concentration of an original sample for a sample measured at a plurality of dilution factors (DFs).
